(19) United States
(12) Patent Application Publication
(10) Pub. No.: US 2004/0013784 A1
(43) Pub. Date: Jan. 22, 2004

(54) Additive method of standardized drinks and potable water production

(76) Inventor: Fortunato Costa, Linda-a-Velha (PT)

Correspondence Address: Fortunato Costa, Av 25 Abril 22 2-D, Linda-A-Velha, 2795-196, PT

(21) Appl. No.: 10/239,621

(22) PCT Filed: Mar. 15, 2001
(86) PCT No.: PCT/PT01/00003

(30) Foreign Application Priority Data
Mar. 16, 2000 (PT) 102430

(51) Int. Cl. C12C 1/00

(52) U.S. Cl. 426/590

(57) ABSTRACT

Additive method of standardized drinks and potable water production from drinks and water (distilled or demineralized), for health profiles is the method of production of Drinks and Potable Water based in the Additives of Transformation For Production Of Standardized Drinks And Potable Water For Health Profiles that are components: solids, liquids, gases and/or energy, specifically manufactured to be added, dissolved, into the Waters. With the objective to transform them into Standardized Drinks and Potable Waters according to the personalized, pre-defined standard HEALTH PROFILES of the Consumers and respecting the international and national organizational regulations that control the minimum and maximum standard characteristics of the Drinks and Potable Water, or of the regional competent authorities where these Drinks and Waters are going to be consumed.

### 1. DEFINITION

The Additive Method Of Standardized Drinks And Potable Water Production From Drinks And Water (Distilled or Demineralized), For Health Profiles is the method of production of Drinks and Potable Water based in the Additives of Transformation For Production Of Standardized Drinks And Potable Water For Health Profiles that are components: solids, liquids, gases and/or energy, specifically manufactured to be added, dissolved, into:

1. Distilled Waters, distilled artificially, by direct human intervention, or distilled naturally, as in the case of rain waters, or the simple condensation of steam water;

2. Demineralized Waters, having relatively low levels of mineralization, being feeble or mineralogical poor waters as in the case of some water springs, fountains, sources, rivers or some public water networks, holes and bottled waters;

3. Drinks, any types of drinks, such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks.

With the objective to transform them into Standardized Drinks and Potable Waters according to the personalized, pre-defined standard HEALTH PROFILES of the Consumers and respecting the international and national organizational regulations that control the minimum and maximum standard characteristics of the Drinks and Potable Water, or of the regional competent authorities where these Drinks and Waters are going to be consumed.

### 2. INVENTION FIELD

The present invention is related with several sciences, from Physics-Chemistry and Nutrition up to Geography and Environment, between others, where the Drinks and Water have an intrinsic impact.

However the application of the invention will be eventually more applied in industries related with the production and distribution of: Potable Water, alcoholic drinks such as breweries of beer, non alcoholic drinks such as sodas, sparkling canned drinks, juices, milks between many others, or eventually in the pharmaceutical industry.

### 3. RETROESPECTIVE

Traditionally, the form to obtain Potable Water—water to drink—it has been based in the collection and use of water directly from the natural resources followed of water treatment processes of Elimination of the pathogenic and harmful particles and elements until it achieves the standards of the Potable Water for human consumption, recommended by the respective competent authorities.

However, the traditional process to obtain Potable Water by Elimination, begins to face three major growing problems:

1. The natural water resources begin to disappear seriously, because even in the year 2000 more than half of the World population has no access to public services of Potable Water;

2. The increasing Pollution of the water resources achieve such amounts that it is not practicable (due to the complexity and to the high costs) to produce Potable Water according to the traditional methods in these regions with higher pollution levels;

3. The two previous problems, associated with the lack of equilibrium between the World Population and the Planetarium Water Resources, besides the economic decline of the poorest Countries: are turning practically impossible to produce Potable Water according to the traditional Elimination method in these Countries, just because the regional potential consumers, probably, will never have money to pay it!

On the other side, the usual Consumer, independently of his health state or Health Profile, has not had alternatives of choice regarding the use of Drinks and Potable Water specially adequate, Standardized, to his own respective Health Profile.

### 4. EVOLUTION

The reality is already in a certain way predictable: the production of Potable Water, in certain regions, has to pass through an opposite process, contrary of the traditional one:

1. Firstly, it is necessary to obtain Distilled Water or Demineralized Water.

The Distilled Water can be obtained from the evaporation of any type of water followed by the posterior condensation of the respective steam water, in multiple processes of purification by distillation (evaporation followed by condensation), or through any other technical or natural process that meanwhile will turn into a more efficient one, technically and commercially, such, for example, the desionazation, or even the combustion of Hydrogen (H₂) in Oxygen (O₂) to obtain Water (H₂O), a well known exothermic reaction. The Distilled Water, commercially named by 100% Pure Water, is already produced industrially and commercialized to drink in many Countries, having a very competitive cost when compared to normal bottled Potable Water, where the transportation cost up to the consumer is, naturally, decisive. In almost all the Asian Countries it is usual to drink Distilled Water, bottled. China is a good example of the low cost of production and consumption of Distilled Water when produced near the consumers and at a very large scale.

The Demineralized Water can be obtained from Water resources, having relatively low levels of mineralization, like in some: natural resources such as water springs, fountains, sources, rivers; or artificial resources such as public water networks, holes and bottled waters;

2. Pollution and the decreasing of potable water resources, associated to demographic, hydrographic and economic inadaptation created a unthinkable situation: “in the beginning of the XXI Century, in certain Planetarium Regions, it is already more profitable to produce industrialized Distilled Water than Potable Water to drink”;

3. However, the Water (Distilled or Demineralized) is prejudicial to public health because it has not the mineral salts and other chemical elements, necessary for a normal healthy daily consumption of any Living Being;

4. So, it is imperative to add and to dissolve, in the Water (Distilled or Demineralized), the Additives of Transformation for Production of Standardized Drinks and Potable Water For Health Profiles to obtain the proper Potable Water for consumption and respecting the international and national organizational regulations that control the minimum and maximum standard characteristics of the Potable Water, or of the regional competent authorities where these waters are going to be consumed;

5. Because it is already possible to pre-define the standards of nutritional needs and/or pathological profiles, HEALTH PROFILES, not only in the richest Countries but also in the poor ones, people only have to choose, accordingly to their health profiles of nutritional needs, and use, in the Water (Distilled or Demineralized), the Additives of Transformation for Production of Standardized Drinks and Potable Water For Health Profiles specially adequate to their respective Health Profiles and respecting the international and national organizational regulations that control the minimum and maximum standard characteristics of the Potable Water, or of the regional competent authorities where this Potable Water is going to be consumed.

On the other side, in what regards the Drinks, because it is already possible to predefine the standards of nutritional needs and/or pathological profiles, HEALTH PROFILES, people only have to choose, accordingly to their health profiles of nutritional needs, and use, in the Drinks they are going to consume, the Additives of Transformation for Production of Standardized Drinks and Potable Water For Health Profiles specially adequate to their respective Health Profiles and respecting the international and national organizational regulations that control the minimum and maximum standard characteristics of the Drinks, or of the regional competent authorities where these Drinks are going to be consumed.

### 5. MANUFECTURING

It exists an enormous legal dependency of the Additives of Transformation for Production of Standardized Drinks and Potable Water For Health Profiles, in front of the competent national and regional authorities—because in fact they are the authorities that control the respective standards of the Drinks and Potable Water, in each Country or Region.

So, the manufacturing of the Additives of Transformation for Production of Standardized Drinks and Potable Water For Health Profiles, whenever possible, will be implemented near the regions where the populations have more nutritional needs, or near the Drinks and Potable Water production industrial zones.

Depending on the Competent Authorities of each Country, the Additives of Transformation for Production of Standardized Drinks and Potable Water For Health Profiles will be manufactured according to the proper legislation of each Country, or Region, following scrupulously the law and the respective minimum and maximum characteristics of the Drinks and Potable Water. In the case of lack of legislation it will be followed the established regulations of the competent international institutions.

On the other side, because of the fact that even the medical science already allows to define HEALTH PROFILE Standards based on the deficient or excessive absorption of vitamins, amino acids, proteins, mineral, or any other elements. The persons easily identify themselves with their own proper Health Profile.

So, The Additives of Transformation for Production of Standardized Drinks and Potable Water For Health Profiles do obey to the following processes:

STANDARDIZED POTABLE WATER=WATER+ADDITIVES and

STANDARDIZED DRINK=DRINK+ADDITIVES

ADDITIVES—The Additives of Transformation for Production of Standardized Drinks and Potable Water For Health Profiles, are formed by the elements and by the chemical compounds needed for the daily human consumption such vitamins, amino acids, proteins, minerals: Calcium, Sodium, Potassium, Magnesium, between others, being, precisely, manufactured according to the nutritional needs defined for each HEALTH PROFILE and the proper legislation of each Country, or Region, following scrupulously the law and the respective minimum and maximum characteristics of the Drinks and Potable Water. In the case of lack of legislation it will be followed the established regulations of the competent international institutions.

WATER—Water (Demineralized or Demineralized) decontaminated and free of harmful elements and compounds for the health such as: chemical organic or inorganic products, microorganisms and radioactive elements.

STANDARDIZED POTABLE WATER—Potable Water specially adequate to the specific needs of each pre-defined HEALTH PROFILE and accordingly to the proper legislation of each Country, or Region, following scrupulously the law and the respective minimum and maximum characteristics of the Potable Water to drink—in the case of lack of legislation it will be followed the established regulations of the competent international institutions.

DRINK—Any types of drinks, such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks.

STANDARDIZED DRINK—Any types of drinks, such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks specially adequate to the specific needs of each pre-defined HEALTH PROFILE and accordingly to the proper legislation of each Country, or Region, following scrupulously the law and the respective minimum and maximum characteristics of the Drinks—in the case of lack of legislation it will be followed the established regulations of the competent international institutions.

The form of presentation of the manufactured product, can also depend on the decision of the Competent Authorities of each Country, so the Additives of Transformation for Pr duction of Standardized Drinks and Potable Water For Health Profiles can be manufactured in the following forms:

Solid Tablets (pills);

Gelatinous Capsules;

Liquid;

Or any other form that the technology and the science meanwhile will discover, such as: gaseous, energy

So, due to the eventual diversification of the regional requirements, the manufacturing process of the Additives of Transformation for Production of Standardized Drinks and Potable Water For Health Profiles probably will have to be really defined Country, by Country.

### 6. DISTRIBUTION

Due to the need to reduce costs, the Transport and Distribution of the Additives of Transformation for Production of Standardized Drinks and Potable Water For Health Profiles can be made directly in the covers, screw-caps, of the bottles or carboys, or in the covers of any other type of packages, of the Drinks and of the Water (Distilled or Demineralized).

To better simplify the Distribution and Transport process, the Additives of Transformation for Production of Standardized Drinks and Potable Water For Health Profiles can also be added and dissolved previously into the Drinks or into the Water (Distilled or Demineralized), in the bottling phase and before covering.

### 7. APLICATION OF THE METHOD IN THE PRODUCTION PHASE

1. In front of the Competent Authorities of each Country, it is presented the Method here patented and it will be asked for all the necessary legal authorizations and corresponding technical and legal appreciation before starting the manufacturing and commercialization of the Additives of Transformation for Production of Standardized Drinks and Potable Water For Health Profiles in the respective Countries;

2. In each Country it is made a survey regarding: (1) the competent authorities, (2) the existing standards and legislation in what concerns the regulations of the characteristics of the Drinks and of the Potable Water for human consumption;

3. In front of the Competent Authorities of each Country, it is asked for the opinion and for the definition, or for the confirmation of the minimum and maximum characteristics of the Drinks and of the Potable Water for human consumption in the Country;

4. After defining the minimum and maximum characteristics for human consumption it is already possible to define qualitatively and quantitatively the elements and the chemical compounds of vitamins, amino acids, proteins, minerals needed to dissolve in the Drinks and Water (Distilled or Demineralized) to obtain the Drinks and the Potable Water for human consumption authorized in the Country;

5. In front of the Competent authorities of each Country, it is asked for the opinions and for the definitions, or for the confirmation of the Health Profiles to define in their respective Country (for example, deficiencies of iron, of calcium, between many others);

6. After defining the Health Profiles it is then possible to decide what types of Additives of Transformation for Production of Standardized Drinks and Potable Water For Health Profiles that should be manufactured and commercialized in the respective Country;

7. Together with the Authorities of each Country it is decided the manufacturing process and the respective intervening quantities to obtain the Additives of Transformation for Production of Standardized Drinks and Potable Water For Health Profiles that should be manufactured and commercialized in each Country;

8. In front of the Competent Authorities of each Country, it is asked for the opinion regarding the form of presentation of the Additives of Transformation for Production of Standardized Drinks and Potable Water For Health Profiles, because they can be manufactured in the following forms:

Solid Tablets (pills);

Gelatinous Capsules;

Liquid;

Or any other forms that the technology and the science meanwhile will discover such as: gaseous, energy.

9. In front of the Competent Authorities of each Country, it is asked for the opinion regarding the Transport and the Distribution of the Additives of Transformation for Production of Standardized Drinks and Potable Water For Health Profiles, it can be made directly in the covers, screw-caps, of the bottles or carboys, or in the covers of any other type of packages, of the Drinks and of the Water (Distilled or Demineralized).

To better simplify the Distribution and Transport process, the Additives of Transformation for Production of Standardized Drinks and Potable Water For Health Profiles can also be added and dissolved previously into the Drinks or into the Water (Distilled or Demineralized), in the bottling phase and before covering;

10. After receiving the official authorizations and legal permissions, are then defined the institutional partnerships for the manufacturing and distribution of the Additives of Transformation for Production of Standardized Drinks and Potable Water For Health Profiles and their respective Standardized Drinks and Potable Waters here Patented, in the respective Country;

11. The ten points above referred can be (or cannot be) implemented in practice, and probably not necessarily by the same order here explained, in reality all it will be depending on the characteristics of each Country.

### 8. APLICATION OF THE METHOD IN THE CONSUMPTION PHASE

1. The Consumer should know what are their own daily nutritional needs at the level of minerals, vitamins, amino acids, proteins, between other compounds. In case of diseases, sickness the Consumer together with his medical doctor can know easily what are the deficiencies (or excesses) of vitamins, amino acids, proteins, or other compounds, in his body system;

2. For each Consumer it can be defined an Health Profile adequate in terms of minerals, vitamins, amino acids, proteins between other compounds necessary to a daily healthy consumption;

3. Depending on the Health Profile definition of the Consumer, he will know which Type of Additives of Transformation for Production of Standardized Drinks and Potable Water For Health Profiles more adjusted to his own personal needs;

4. The Consumer needs then to acquire the Drinks or the Water (Distilled or Demineralized) and the respective Additives of Transformation for Production of Standardized Drinks and Potable Water For Health Profiles more suitable to his own respective Health Profile;

5. Probably, the bottle or the carboy of Drink or Water already have dissolved their own respective Additives of Transformation for Production of Standardized Drinks and Potable Water For Health Profiles, in this situation the Drink or the Potable Water are already Standardized to the respective Health Profile and ready for consumption;

6. In the case that the Additives are not yet dissolved in the Drinks or in the Water, the Consumer needs then to introduce the Additives of Transformation for Production of Standardized Drinks and Potable Water For Health Profiles in the recipient of the Drink or of the Water (Distilled or Demineralized), and let them dissolve themselves, obtaining then the Standardized Drinks or Potable Water more adequate, Standardized, to his own specific personal needs;

7. The six points above referred can be (or cannot be) implemented in practice, and probably not necessarily by the same order here explained, in reality all it will be depending on the characteristics of each Country.

### 9. COMPOSITION OF THE ADDITIVES OF TRANSFORMATION FOR PRODUCTION OF STANDARDIZED DRINKS AND POTABLE WATER FOR HEALTH PROFILES

The perennial and chronicle state of basic nutrient rarefaction of (Vitamins, Amino Acids, Minerals, Proteins) is the cause of the constant fatigue that frequent reaches people, the weakness of the body without apparent cause, undisposals, the reduction of the defense capacity of the immunological system, the frequent alterations of the sap, the chronide and incurable illnesses, the obesity, the trend to alcoholism and the use of drugs, the unsatisfaction related with the profession, familiar life and society.

The Composition of the Additives of Potable Transformation for Production of Standardized Potable Water For Health Profiles here presented, in reality it will be variable and taking in account several factors, between them the real Health Profiles to Pre-define and to select commercially, as also the permanent evolution of the human science, or the diversity from Country to Country.

We indicate here only the principal chemical elements and compounds that form the Composition of the Additives of Potable Transformation for Production of Standardized Potable Water For Health Profiles—formed by Vitamins, Minerals, Amino Acids, Proteins between others, in a composition that normally is dissolved into the Drinks or into the Water (Distilled or Demineralized) staying there generally in ionic state as positives ions (cations) or negatives (anions):

Vitamins

The vitamins are necessary organic substances to The Life, essentials for the normal functioning of the body system and, with some exceptions; they cannot be produced nor be synthesized by the organism. They are necessary to the growth, vitality and general well being. In natural state, they can be found, in minimum amounts, in all the organic foods. Being necessary to obtain them by ingesting these dietary foods or appendages. The vitamins are components of the enzymatic system that put in functioning and regularize the metabolism of the organism. The deficiency of only one vitamin can put in danger the entire organism. As the vitamins are natural substances found in foods, the appendages token—capsules, tablets, dust or liquids—also come from foods. Although many of vitamins can be synthesized, the majority of them are extracted of basic natural sources.

a) VITAMIN A (Liposoluble) <from 0 to 10 000 U.I., human daily consumption>Combat the night blindness, tired sight and collaborates in the handling of diverse visual problems; It helps the functioning of the immunological system; It promotes the growth, healthful formation of strong bones, skin, hair, teeth and gums; Resistance creation and assists in the handling of respiratory infections, it reduces the time of duration of the illnesses; Applied externally, it helps in the treatment of furuncles and ulcers, acne, bubbles and wrinkle; It assists the handling of emphyzema and the hyperthyroidism; It is more efficient when it is used in set with the complex B, vitamin D and E, Calcium, Phosphorus and Zinc; It offers protection against cancerigenic agents, for example the free radicals;

b) COMPLEX B—The vitamins of the complex B associated, are more efficient than when used in an isolated way. The complex B is used in the cases of appetite loss and in difficult digestion, assisting the good functioning of the liver and intestines. Especially indicated in the cases of depression and irritability, it promotes a healthful nervous system. It assists in the rub-out of excesses of fats and sugars for diabetes. It improves the mental alert and it alleviates the fatigue;

c) VITAMIN B1 (Thiamine-hydrosoluble) <from 0 to 3 mg, human daily consumption>—It is known as the “vitamin of the sap”; It facilitates the digestion; It is important for the normal functioning of the nervous system, heart and muscles; It assists in the treatment of herpes-zoster; It helps to fight nausea in the maritime and aerial trips; It promotes the growth; It magnifies the mental disposal; Indicated especially in the cases of: Pregnancy, suckles, smokers and people who ingest contraceptive pills and alcoholic beverages;

d) VITAMIN B2 (Riboflavin-hydrosoluble) <from 0 to 4 mg, human daily consumption>—It benefits the vision, alleviates the ocular fatigue; It assists in the growth and the reproduction; It assists in the cicatrization of wounds in the mouth, lips and tongue; It makes more healthful the skin, nails and hair; The necessity increases in situations of fatigue, pregnancy, diabetes and use of contraceptive pills;

e) VITAMIN B3 (Niacin-hydrosoluble) <from 0 to 3 mg, human daily consumption >—It supplies more energy for the adequate use of foods; It provides a more healthful and pretty skin; It helps to prevent and to alleviate pain provoked by Headache; It stimulates the circulation and it reduces the high blood pressure; It alleviates some forms of diarrhea; It helps in the reduction of the cholesterol and the triglicerides; Necessary for hormonal synthesis;

f) VITAMIN B5 (Pant th nic-hydrosoluble acid) <from 0 to 3 mg, human daily c nsumption>—It reduces the toxic effect of many antibiotics; Important in the formation of the antibodies, helping in the combat against the infections; It prevents fatigue; It helps in the cicatrization of wounds;

g) VITAMIN B6 (Pyridoxine-hydrosoluble) <from 0 to 4 mg, human daily consumption>—It reduces night muscular contractions, cramps, dormancy and certain forms of neuritis in the extremities; It is a natural diuretic; It assists in the reduction of the aging; It alleviates nausea, also of the pregnancy; It alleviates menstrual pains;

h) VITAMIN B12 (Cobalamine-hydrosoluble) <from 0 to 10 μg, human daily consumption>—It keeps the balance of the nervous system; It provides more energy; It promotes the growth and it increases the appetite; Important in the formation and regeneration of red globules, preventing the anemia;

i) FOLIC ACID (Folacin-hydrosoluble) from 0 to 800 μg, human daily consumption>—It aids in the metabolism of proteins; It increases the lactation; It helps to fight the anemia; It promotes a more healthful appearance to the skin; It can delay the white hair if ingested with B5 and PABA; It acts as preventive in oral ulcers; It increases the appetite;

j) BIOTINE <from 0 to 60 μg, human daily consumption>—Essential for the vitamin C synthesis; It calms muscular pains; It assists in the preventive treatment of the baldness; It alleviates eczema and the dermatitis;

k) VITAMIN C (Ascorbic-hydrosoluble Acid) <from 0 to 100 mg, human daily consumption>—It offers protection against cancerigenic agents, for example the free radicals; It assists in the prevention of some types of infections, you capsize, viral or bacterial acting in the strengthening of the immunological system; It diminishes the incidence of blood clots in the veins; It heals wounds, burnings, gums that bleed, besides speeding up the after-surgical cicatrization; It draws out the life, allowing that the cells are kept together; It helps in the treatment of colds and grippes; It increases the effectiveness of medicines used in the treatment of infections of the urinary system; It helps to lower down the cholesterol level; The carbon monoxide destroys vitamin C—therefore, the inhabitants of the cities must take greater amounts of this vitamin; The users of the contraceptive pill also need higher doses of vitamin C; It acts in the formation of the Collagen; It is more efficient taking with Bioflavonoides, Calcium and Magnesium; It helps the organism to absorb the Iron; The Smokers have greater vitamin C needs;

l) VITAMIN D (Calciferol-lip soluble) <from 0 to 800 U.I., human daily c nsumpti n>—Used together with the vitamins A and C, it can help in the prevention of colds; It helps in the treatment of conjunctivitis; It aid the assimilation of the vitamin A; It adequately uses Calcium and the Phosphorus, needed for the formation of teeth and strong bones;

m) VITAMIN E (Tocopherol-liposoluble) <from 0 to 60 U.I., human daily consumption>—It protects the lungs of the atmospheric pollution, acting in set with the vitamin A; It diminishes the risks of ischemias in the cardiac illnesses; It alleviates the fatigue; It diminishes the risk of aborts; It supplies of the oxygen of the organism, providing bigger resistance; It speeds up the cicatrization of burnings; It prevents the formation of thick scars (keloids, crusts) internally and externally; Pregnant women and in period of lactation, as well as those that are taking contraceptives or hormones need bigger amounts of vitamin E; Together with vitamin C, the Beta-carotene, (vitamin A) and the Selenium, delay the aging of the cells from the oxidation; Efficient in the prevention of the Cancer;

n) VITAMIN K (Menadione) <from 0 to 50 μg, human daily consumption>—Soluble in the lipids. It helps in the prevention of hemorrhages and internal bleeds. It contributes for the reduction of excessively abundant menstrual streams. It provides a convenient sanguineous coagulation;

o) VITAMIN K1 (Phytonadione) <from 0 to 50 μg, human daily consumption>—It helps in the prevention of hemorrhages and internal bleeds. It contributes for the reduction of excessively abundant menstrual streams. It provides a convenient sanguineous coagulation;

p) VITAMIN P (Bioflavonoids) from 0 to 50 μg, human daily consumption>—It is soluble in the water. Necessary for the perfect absorption and functioning of the vitamin C. It avoids that the vitamin C is destroyed by the oxidation. It helps to increase the resistance to the infections. It prevents and cures the bleed of gums. The women who are in the period of the menopause can find some relief for the heat waves by increasing the dose of Bioflavonoids;

q) PARA-AMINOBENZOIC ACID (PABA) <from 0 to 50 μg, human daily consumption>—Soluble in the water. It helps to form the folic acid and it is important in the use of proteins. It has the property to filter the solar rays. It keeps the healthful and soft skin. It helps in the retardation of wrinkles. It helps to restore the natural color of the hair;

r) PANTOTHENIC ACID <from 0 to 20 μg, human daily consumpti n>—;

s) NIACINAMIDE from 0 to 40 mg, human daily consumption>—.

Minerals

As Vitamins, the Minerals allow that the body carries through its activities efficiently. They are necessary for the adequate composition of the body fluids, formation of the blood and bones and in the healthful maintenance of the nervous system; the minerals are elements that exist naturally in the Nature in Inorganic and Organic forms, pure or in compounds such as the mineral salts.

For the human organism the Minerals belong to two groups: (1) the Minerals In Quantity and (2) Trace Minerals (Vestige Minerals or Oligo Elements).

In Minerals In Quantity it exists: Calcium (Ca), Magnesium (Mg), Sodium (Na), Potassium (K) and Phosphorus (P); these are necessary in larger amounts than of the Trace Minerals (Vestige Minerals or Oligo Elements). Although the Trace Minerals (Vestige Minerals or Oligo Elements) are necessary only in lowermost amounts, they are also important for a good health.

Between the Trace Minerals (Vestige Minerals or Oligo Elements), it exists: Zinc (Zn), Iron (Fe), Copper (Cu), Manganese (Mn), Chromium (Cr), Selenium (Se), Iodine (I), among others.

a) CALCIUM (Ca) <from 0 to 300 mg, human daily consumption>—Together with the Phosphorus, they work to form healthy teeth and bones; With Magnesium, they act to keep the cardiovascular system healthy, keeping constant the cardiac beatings; To absorb Calcium, the organism must make use of a enough amount of vitamin D; It helps to metabolize the Iron of the organism; It diminishes the insomnia; It collaborates with the nervous system; It prevents rachitis, osteomalacia, osteoporosis;

b) CALCIUM OF SHELLS OF OYSTERS <from 0 to 300 mg, human daily consumption>—It is an natural product extracted from the shell of oysters, that associated to vitamin D, is absorbed more quickly by the organism than from other sources. Especially it is indicated in the symptoms of osteoporosis in more advanced ages. Its use complements the feed in children and young in the growth phase, assisting in the good formation of the bones and of the teeth;

c) CALCIUM (Ca)—MAGNESIUM (Mg)—ZINC (Zn)—This association is indicated for people with mental and physical stress, with symptoms of nervousness, fatigue, insomnia or appetite loss. Its action becomes notably as an important tonic for the organism, strengthening notably the metabolism of proteins, normalizing the gland functions and fortifying muscles and bones. It helps in the prevention of the cholesterol excesses, in circulation. It has proven effects in the treatment of the prostate;

d) CHLORINE (Cl) <from 0 to 60 mg, human daily consumption>—It regulates the acid-basic balance of the blood. It helps to eliminate the metabolites of the organism, helping the functioning of the liver. It assists the digestion. It helps to keep flexibility. It is present in the majority of the multi mineral preparations;

e) FLUOR (F) <from 0 to 4 mg, human daily consumption>—It helps to form and to keep an healthful dentition during all the life;

f) CHROMIUM (Cr) <from 0 to 50 μg, human daily consumption>—Associated with the insulin in the sugar metabolism, it acts contributing to control diabetes; It helps to take the protein for the points where it is more necessary contributing in the growth; It helps to prevent or to lower down the arterial pressure;

g) IRON (Fe) <from 0 to 40 mg, human daily consumption>—Necessary for the hemoglobin production; It helps in the prevention and in the treatment of anemia caused for the iron lack; It prevents the fatigue, it aids in the growth, it promotes resistance to the diseases;

h) PHOSPHORUS (P) <from 0 to 300 mg, human daily consumption>—It is present in each cell of the body; It is important for the regularity of the heart; It provides the energy and vigor; It diminishes pains of the arthritis; It promotes the health of the gums and teeth;

i) IODINE (I) <from 0 to 300 μg, human daily consumption>—It promotes an adequate growth; It provides more energy; It keeps healthful, the hair, nails, skin and teeth; It improves the mental activity; It collaborates in the diets, burning the fat excesses; The natural seaweed is a good iodine source;

j) MAGNESIUM (Mg) <from 0 to 200 mg, human daily consumption>—Known as the Anti-Stress Mineral. The Athletes need a larger quantity of magnesium. The women that are using contraceptive pills or making repositions of estrogens need to assimilate foods with high amounts of magnesium. The chloride of magnesium is a good source. It alleviates the indigestion. It develops a more healthful cardiovascular system. It helps to prevent the deposits of Calcium in the kidneys and in the vesicle. Indispensable for the good functioning of the nerves and the muscles. It assists in the combat against the depression;

k) MANGANESE (Mn) <from 0 to 5 mg, human daily consumption>—It helps to improve the memory; Asset muscular reflexes; It helps to waste the fatigue; It assists in the nervous irritation; It helps in the prevention of osteoporosis; Necessary for a normal bone structure;

l) POTASSIUM (K) <fr m 0 to 80 mg, human daily consumpti n>—Together with Sodium, it works to keep the water balance in the body and to regularize the rhythm of the cardiac beatings; It helps to lower the blood pressure; it collaborates in the treatment of allergies;

m) SELENIUM (Se) <from 0 to 50 jig, human daily consumption>—It helps to keep the natural elasticity of tissues; Together with the vitamin E, it prevents the aging; It alleviates the waves of heat of the menopause; It collaborates in the treatment and prevention of scurf;

n) SODIUM (Na) <from 0 to 150 mg, human daily consumption>—With the potassium it is essential for a normal growth; It contributes for the proper functioning of the nerves and muscles; It helps to prevent the prostration due to the heat and the insolation; The best sodium appendage are the seaweed;

o) ZINC (Zn) <from 0 to 30 mg, human daily consumption>—It promotes the maintenance of the cells; Essential for the protein synthesis; It controls the capacity of muscles contractions; It helps in the formation of the insulin; It speeds up the time of cicatrization of internal and external wounds; Important in the cerebral function leaving the mind most alert; Regulator of the prostate assisting to prevent prostatitis; It assist in the reduction of the cholesterol deposits; It stimulates the growth; It helps in the menstrual irregularities; Good results in the treatment of the impotence;

p) COPPER (Cu) <from 0 to 4 mg, human daily consumption>—Useful for the hemoglobin production and to prevent anemia; It is necessary for some enzymatic reactions; Deficiencies of copper provoke inefficiency in the use of iron and proteins, provoking diarrhea, cholesterol, mental and emotional problems, thyroid gland problems;

q) GOLD (Au) <from 0 to 20 μg, human daily consumption>—It combats the bacillus of the Tuberculosis and the Arthritis; It improves the cerebral functions, depressions; Circulation problems; Glandular, digestive disorders; Cancer;

r) SILVER (Ag) <from 0 to 20 μg, human daily consumption>—It is a powerful natural antibiotic. It eliminates more than 650 different bacteria, fungus, virus and illnesses provoked by microorganisms;

s) TIN (Sn) <from 0 to 20 μg, human daily consumption>—;

t) MOLIBDENIUM (Mo) <from 0 to 50 μg, human daily consumption>—;

u) NICKEL (Ni) <from 0 to 10 μg, human daily consumption>—;

v) SILICIUM (Si) <fr m 0 to 20 μg, human daily consumption>—;

w) VANADIUM (V) <from 0 to 20 μg, human daily consumpti n>;

Proteins and Amino Acids

The proteins are a vital necessity in the nutrition of the man and all the animals. The amino acids, matched with the nitrogen, form thousand of different proteins (there are twenty-two known amino acids).

So that the organism uses and synthesizes in efficient mode the proteins, it is necessary that all the amino acids are present, in the adequate ratios. The absence, even still temporary, of a single essential amino acid can affect negatively the synthesis of the proteins. If it will have little amount or to lack of any essential amino acid, the effectiveness of all excessively will be reduced in the same ratio. Although they are produced from the same twenty-two amino acids, the proteins are not equal, presenting different functions and working in different parts of the body.

Basically, it there are two types of proteins: (1) Complete and (2) the Incomplete ones. The Complete Proteins provide the adequate balance of eight necessary amino acids for the formation of tissues and are found in foods of animal origin such as Birds, Meats, Fish, Shellfishes or Seafood, Eggs, Milk and Cheese.

The Incomplete Proteins do not possess all the essential amino acids and they are not used in an efficient mode, when ingested separately. However, if they are matched with small amounts of proteins of animal origin, they become Complete. They are found in Seeds, Nuts, Peas, Grains and Beans. The mixture of the two types of proteins can better propitiate a better nutrition than, if it would make, any of them separately.

Amino Acids

a) ASPARTIC ACID from 0 to 100 μg>—It stimulates the immunological system; It increases the vigor and the resistance; it banishes from the organism the dangerous ammonia;

b) GLUTAMIC ACID <from 0 to 100 μg>—It improves the cerebral functions; it alleviates the fatigue; it contributes to shorten the time of cicatrization of ulcers; it functions as a stimulator of the good sap;

c) ALANINE <from 0 to 100 μg>—It improves the immunological system; It diminishes the risk of rocks in the kidneys; It helps to attenuate the hypoglycemia;

d) ARGININE <from 0 to 100 μg>—It increases the tally of sperm; It speeds up the cicatrization of wounds; It acts as a tonic to the muscular tissues;

e) BCAA—AMINO ACID CHAINS <from 0 to 100 μg>—Compounds of leucine, valine and isoleucine, are natural anabolic appendages. They regulate the use of the protein by the organism and have a singular paper in the metabolism of proteins in the muscles;

f) CYSTEINE <from 0 to 100 μg>—It helps to prevent the boldness; It alleviates psoriases; It improves the state of the hair, skin and nails;

g) FENILANINE <from 0 to 100 μg>—It acts as antidepressant; it helps to diminish the appetite; it can function, in some formulas, as a natural analgesic;

h) GLYCINE <from 0 to 100 μg>—Useful in the treatment in the disorders of the pituitary gland, and as it supplies the organism with more creatine (essential for the functioning of the muscles), also revealed efficient in the treatment of progressive muscular dystrophy, many medical nutritionists use the glycine in the treatment of the hypoglycemia, it is efficient in the handling of the gastric hyperacidity (it is part of many antacids);

i) HISTIDINE <from 0 to 100 μg>—It helps to alleviate the arthritis; it alleviates stress; it helps to magnify the sexual interest;

j) L-CARNITINE <from 0 to 100 μg>—Recent research had indicated that it not only has an important paper in the conversion of the fat stored in the organism in energy as also can help to control the hypoglycemia, reduces the angina attacks and benefits the carrying patients of diabetes, illnesses of the liver and kidneys. It is being used also for athletes, allowing carrying more intense exercises through longer periods of time. The heart depends on the L-carnitine, and the deficiency of this amino acid can cause the weakness of coronary tissues. The main natural sources are the meats and the derivatives of milk;

k) LYSINE <from 0 to 100 μg>—it improves the mental concentration; the fertility and to prevent infections for simple herpes;

l) METHYONINE <from 0 to 100 μg>—It helps to lower down the cholesterol percentage, in the treatment of the schizophrenia and the Illness of Parkinson; it can prevent the formation of tumors;

m) ORNITHINE <from 0 to 100 μg>—If functions like an Hormone that acts in the formation of muscles; It increases the power of the arginine;

n) PROLINE <from 0 to 100 μg>—It helps in the cicatrization, it increases the capacity to learn;

) SERINE <from 0 to 100 μg>—It helps to alleviate pain; it can act as a natural antipsychotic;

p) TYROSINE <from 0 to 100 μg>—It increases the sexual desire, alleviates stress; it can act as suppressor of the appetite and stimulator of the good sap;

q) THREONINE <from 0 to 100 μg>—Needed for the use of diets proteins;

r) TRYPTOPHANE <fr m 0 to 100 μg>—It helps to diminish the anxiety; in the induction to sleep; It can be a coadjutant in the control of alcoholism.

ps Proteic Suplements

<From 0 to 200 mg>—They are indicated for those people who do not satisfy its daily protein necessities with integral foods. The best formulas are prepared from soy, white part of the egg, the skimmed milk serum that contains all the essential amino acids. These can be presented in the liquid form or dust, without carbohydrates or fats, and generally they supply about 26 g protein each 28 g of preparation. The appendages can easily be added to foods, liquids or solids. They have specific properties to improve the health—since perfecting the immunological system until reducing the dependence of drugs.

Extra Suplements

a) ACIDOPHILUS <from 0 to 50 mg>—It is about the lactobacillus acidophilus that, with the fermentation of carbohydrate originates the lactic acid, that lows down the pH, acidifying the intestinal system, with this hindering or making difficult the development of pathogenic flora in the intestine. Mainly during treatments by antibiotics and chemotherapy by oral absorption, lactobacillus acidophilus protect the normal intestinal flora;

b) ODOURLESS GARLIC <from 0 to 50 mg>—The rich composition of the oil of garlic (Potassium, Phosphorus, Calcium, Proteins, Vitamins C and Complex B), presented in deodorized form that, beyond rich in amino acids, guarantees the non existence of odor in the breath or pores. It is antibiotic and reducer of the cholesterol and high blood pressure;

c) ENZYME OF PAPAYA <from 0 to 50 mg>—Digestive enzyme, extracted from the papaya, it helps the digestion of proteins and starch. It combats the extreme stomach acidity, preventing the acidity. It is important also because the digestive action liberates vitamins, minerals and amino acids of foods;

d) OMEGA 3—EPA <from 0 to 50 mg>—Unsaturated oil (without fats) and without metals weighed, extracted of the salmon. It contains EPA (eicosapentaenoic acid) and DHA (decosahexaenoic acid) and vitamins, A, B and E. Indicated for the reduction of the cholesterol level and prevention of arterioscleroses. Diabetics must avoid it; therefore it was verified that it produces an increase of the tax of glicemia in the diabetics, being these reversible effect with the suspension of the appendage.

### 10. HEALTH PROFILES

This patent is destined essentially to the satisfaction of the biological necessities of nutrition through the regular use of Standardized Drinks and P table Waters, here patented, according to the personalized, pre-defined standard HEALTH PROFILES of the Consumers and respecting the international and national organizational regulations that control the minimum and maximum standard characteristics of the Drinks and Potable Water, or of the regional competent authorities where these Drinks and Waters are going to be consumed.

So here are presented some of the Illnesses and Classifications that will be used for the Definition and Classification of the HEALTH PROFILES that the Additives of Potable Transformation for Production of Standardized Potable Water For Health Profiles will satisfy through the Method here Patented: Abscesses; Uric Acid—Gout; Acne; Aphthas; Alcoholism; Allergies; Breast-feeding; Amygdalitis; Anemia; Angina; Anxiety—Anguish—Affliction; Anorexia; Arterioscleroses; Arthritis; Asthma; Bronchitis; Bursitis; Candidiasis—candid albicans; Renal Calculus in Kidneys and Vesicle; Cancer; Cataracts; Growth; High Cholesterol; Colitis; Column—pain in the coasts; Conjunctivitis; Depressions; Depurative of the blood; Dehydration; Malnutrition; Hormones Clutters; Sports—Athletes; Diabetes Mellitus; Diarrhea; Dyspepsia, indigestion, digestive clutter; Diverticulitis; Illnesses of the Genetic Forum (Genetic Disorders); Illnesses of the Psychological Forum; Illnesses of the Psychiatric Forum; Illnesses of Bones; Pains of Ear; Illnesses of the Skin; Illnesses of the Alimentary and Digestive System; Illnesses of the Cardiovascular System; Illnesses of Sanguineous Circulatory System; Illnesses of the Hepatic System; Illnesses of the Immunological System, Illnesses of the Lymphatic System; Illnesses of the Nervous System; Illnesses of the Ophthalmologic System; Illnesses of the Respiratory System; Illnesses of the Sexual System; Illnesses of the Urinary and Renal System; Eczema; Edema; Emphysema; Nausea (car, boat); Fatigue; Fever; Flatulence—gases—dyspepsia; Fleabite; Fractures; Frigidness; Tobacco (abuse); Fungus; Gastritis; Gingivitis; Glaucoma; Grippes—Colds; Haematoma; Simple Herpes; Urinary incontinence; Bacterial Infections; Infections You capsize; Infertility; HIV/AIDS; Leukemia; Malaria; Maternity; Bad breath; Menopause; Nausea—vomit; Nutrition; Obesity; Corporal odor; Osteoporosis; Pediatrics; Pricked of flyers and bees; Pneumonia; High Arterial Pressure; Arterial Pressure Decrease; Arrest of womb; Menstrual problems; Prostate; Puberty; Kidneys; Fall of hair; Burnings; Rheumatism; Sinusitis; Twist—muscular distension; C ugh; Toxic-dependence—Drugs; Ulcer; Oldness; Worms; Vesicle.

1. ADDITIVE METHOD OF STANDARDIZED DRINKS AND POTABLE WATER PRODUCTION FROM DRINKS AND WATER (DISTILLED OR DEMINERALIZED), FOR HEALTH PROFILES characterized by being based in the Additives of Transformation For Production Of Standardized Drinks And Potable Water For Health Profiles, specifically produced to be added, dissolved, into the Drinks and into the Waters (Distilled or Demineralized) with the objective to obtain, respectively, Drinks and Potable Water of high quality and Regionally Standardized for Specific and/or Pre-defined Health Profiles, of the Consumers:

2. Method according to the claim 1, characterized by the fact that the Distilled Waters used, in this patent, can be distilled artificially, by direct human intervention, or distilled naturally, as in the case of Rain waters, or the simple condensation of steam water.

3. Method according to the claim 1, characterized by the fact that the Demineralized Waters used, in this patent, can be obtained from water resources, having relatively low levels of mineralization, like in some: natural resources such as water springs, fountains, sources, rivers; or artificial resources such as public water networks, holes and bottled waters.

4. Method according to the claim 1, characterized by the fact that the Drinks used, in this patent, can be any types of drinks, such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks.

5. Method according to the claims 1, 2 and 3, characterized by to be a Potable Water production method that is different from the traditional methods and that is oriented as a profitable and rational solution that responds to the increasing lack of natural water resources and to the magnifying pollution that it exists, more and more, in many planetary regions.

6. Method according to the claims from 1 to 4, characterized by to be a Method that presents a solution more rational than the actual existing Drinks and Potable Waters—bottled, natural or from public networks—producing the Drinks and the Potable Water specially having in attention the necessity of its adaptation to the different Health and Nutritional needs of each Human Being, and in establishing a Cause-Effect relation that permits to satisfy the health and nutritional deficiencies, regionally, locally and/or at a large scale.

7. Method according to the claims from 1 to 6, characterized by the fact that the Drinks and the Potable Waters produced, in this patent, can be Standardized Regionally because the production of the Additives of Potable Transformation for Production of Standardized Potable Water For Health Profiles is made according to the proper regulations of each Country, or Region.

8. Method according to the claims from 1 to 7, characterized by the fact that the Drinks and the Potable Water produced, in this patent, are following scrupulously the law and the respective minimum and maximum characteristics of the Drinks and Potable Water, of each Region or Country, in the case of lack of legislation it will be followed the established regulations of the competent international institutions.

9. Method according to the claims from 1 to 8, characterized by the fact that the medical science already allows to create HEALTH PROFILE Standards based on the deficient or excessive absorption of vitamins, amino acids, proteins, mineral, or any other element, being then possible to pre-define this Standards of nutritional disorders and/or Pathological Profiles—HEALTH PROFILE—not only in the rich Countries but also in the poor ones.

10. Method according to the claims from 1 to 9, characterized by the fact that the Drinks and the Potable Water produced, in this patent, are Standardized to the Personalized and Pre-defined HEALTH PROFILES of the Consumers, just because the production of the Additives of Potable Transformation for Production of Standardized Potable Water For Health Profiles is made specifically for the satisfaction of the nutritional necessities, deficiencies or excesses, of minerals, amino acids, vitamins, proteins, or other elements, of the Consumers.

11. Method according to the claims from 1 to 10, characterized by the fact that the Consumers only have to choose, accordingly to their health profiles of nutritional needs—HEALTH PROFILES—and use in the Drinks or in the Water (Distilled or Demineralized) the type of Additives of Potable Transformation for Production of Standardized Potable Water For Health Profiles specially adequate, Standardized, to their own Health Profiles.

12. Method according to the claims from 1 to 11, characterized by the Additives of Potable Transformation for Production of Standardized Potable Water For Health Profiles do obey to the following processes:
STANDARDIZED POTABLE WATER=WATER+ADDITIVES and
STANDARDIZED DRINK=DRINK+ADDITIVES

13. Method according to the claim 12, characterized by the ADDITIVES—The Additives of Transformation for Production of Standardized Drinks and Potable Water For Health Profiles used, in this patent, being formed by the elements and by the chemical compounds needed for the daily human consumption such vitamins, amino acids, proteins, minerals: Calcium, Sodium, Potassium, Magnesium, between others

14. Method according to the claims 2, 3 and 12, characterized by the WATER—Water (Distilled or Demineralized) used, in this patent, being decontaminated and free of harmful elements and compounds for the health such as: chemical organic or inorganic products, microorganisms and radioactive elements.

15. Method according to the claim 12, characterized by the STANDARDIZED POTABLE WATER—Potable Water produced, in this patent, being adequate to the specific needs of each pre-defined HEALTH PROFILE and accordingly to the proper legislation of each Country, or Region.

16. Method according to the claims 4 and 12, characterized by the DRINK—Drinks used, in this patent, can be any types of drinks, such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks.

17. Method according to the claim 12, characterized by the STANDARDIZED DRINK—The Drinks produced, in this patent, can be any types of drinks such as milks, drinkable yogurts, coffees, teas, chocolates, shakes, juices, sodas, sparkling canned drinks, beers, wines, liquors, brandies, whisky, spirituous drinks, white drinks, between many others alcoholic and non alcoholic drinks, but specially adequate to the specific needs of each pre-defined HEALTH PROFILE and accordingly to the proper legislation of each Country, or Region.

18. Method according to the claims from 1 to 17, characterized by the fact that the form of the presentation of the Additives of Transformation for Production of Standardized Drinks and Potable Water For Health Profiles can be manufactured in the following forms:
Solid Tablets (pills);
Gelatinous Capsules;
Liquid;
Or any other forms that the technology and the science meanwhile will discover such as: gaseous, energy.

19. Method according to the claims from 1 to 18, characterized by the fact that due to the need to reduce costs, the Transport and Distribution of the Additives of Transformation for Production of Standardized Drinks and Potable Water For H alth Profiles can be made directly in the covers, screw-caps, of the bottles or carboys, or in the covers of any other type of packages, of the Drinks and of the Water (Distilled or Demineralized).

20. Method according to the claims from 1 to 19, characterized by the fact that to better simplify the Distribution and Transport process, the Additives of Transformation for Production of Standardized Drinks and Potable Water For Health Profiles can also be added and dissolved previously into the Drinks or into the Water (Distilled or Demineralized), in the bottling phase and before covering.

21. Method according to the claims from 1 to 20, characterized by possibly being applied accordingly to the following Application Method in the Production Phase:
1. In front of the Competent Authorities of each Country, it is presented the Method here patented and it will be asked for all the necessary legal authorizations and corresponding technical and legal appreciation before starting the manufacturing and commercialization of the Additives f Transformation for Production of Standardiz d Drinks and Potable Water For Health Profiles in the respective Countries;
2. In each Country it is made a survey regarding: (1) the competent authorities, (2) the existing standards and legislation in what concerns the regulations of the characteristics of the Drinks and of the Potable Water for human consumption;
3. In front of the Competent Authorities of each Country, it is asked for the opinion and for the definition, or for the confirmation of the minimum and maximum characteristics of the Drinks and of the Potable Water for human consumption in the Country;
4. After defining the minimum and maximum characteristics for human consumption it is already possible to define qualitatively and quantitatively the elements and the chemical compounds of vitamins, amino acids, proteins, minerals needed to dissolve in the Drinks and Water (Distilled or Demineralized) to obtain the Drinks and the Potable Water for human consumption authorized in the Country;
5. In front of the Competent authorities of each Country, it is asked for the opinions and for the definitions, or for the confirmation of the Health Profiles to define in their respective Country (for example, deficiencies of iron, of calcium, between many others);
6. After defining the Health Profiles it is then possible to decide what types of Additives of Transformation for Production of Standardized Drinks and Potable Water For Health Profiles that should be manufactured and commercialized in the respective Country;
7. Together with the Authorities of each Country it is decided the manufacturing process and the respective intervening quantities to obtain the Additives of Transformation for Production of Standardized Drinks and Potable Water For Health Profiles that should be manufactured and commercialized in each Country;
8. In front of the Competent Authorities of each Country, it is asked for the opinion regarding the form of presentation of the Additives of Transformation for Production of Standardized Drinks and Potable Water For Health Profiles, because they can be manufactured in the following forms:
Solid Tablets (pills);
Gelatinous Capsules;
Liquid;
Or any other forms that the technology and the science meanwhile will discover such as: gas-ous, energy.
9. In front of the Competent Authorities of each Country, it is asked for the opinion regarding the Transport and the Distribution of the Additives of Transformation for Producti n of Standardized Drinks and Potable Water For H alth Profiles, it can be made directly in the covers, screw-caps, of the bottles or carboys, or in the covers of any other type of packages, of the Drinks and of the Water (Distilled or Demineralized). To better simplify the Distribution and Transport process, the Additives of Transformation for Production of Standardized Drinks and Potable Water For Health Profiles can also be added and dissolved previously into the Drinks or into the Water (Distilled or Demineralized), in the bottling phase and before covering;
10. After receiving the official authorizations and legal permissions, are then defined the institutional partnerships for the manufacturing and distribution of the Additives of Transformation for Production of Standardized Drinks and Potable Water For Health Profiles and their respective Standardized Drinks and Potable Waters here Patented, in the respective Country;
11. The ten points above referred can be (or cannot be) implemented in practice, and probably not necessarily by the same order here explained, in reality all it will be depending on the characteristics of each Country.

22. Method according to the claims from 1 to 21, characterized by possibly being applied accordingly to the following Application Method in the Consumption Phase:
1. The Consumer should know what are their own daily nutritional needs at the level of minerals, vitamins, amino acids, proteins, between other compounds. In case of diseases, sickness the Consumer together with his medical doctor can know easily what are the deficiencies (or excesses) of vitamins, amino acids, proteins, or other compounds, in his body system;
2. For each Consumer it can be defined an Health Profile adequate in terms of minerals, vitamins, amino acids, proteins between other compounds necessary to a daily healthy consumption;
3. Depending on the Health Profile definition of the Consumer, he will know which Type of Additives of Transformation for Production of Standardized Drinks and Potable Water For Health Profiles more adjusted to his own personal needs;
4. The Consumer needs then to acquire the Drinks or the Water (Distilled or Demineralized) and the respective Additives of Transformation for Production of Standardized Drinks and P table Water For Health Profiles more suitable to his own respective Health Profile;
5. Probably, the bottle or the carboy of Drink or Water already have dissolved their own respective Additives f Transformation f r Pr ducti n of Standardized Drinks and P table Water For Health Pr files, in this situation the Drink or the P table Water are already Standardized to the respective Health Profile and ready for consumption;
6. In the case that the Additives are not yet dissolved in the Drinks or in the Water, the Consumer needs then to introduce the Additives of Transformation for Production of Standardized Drinks and Potable Water For Health Profiles in the recipient of the Drink or of the Water (Distilled or Demineralized), and let them dissolve themselves, obtaining then the Standardized Drinks or Potable Water more adequate, Standardized, to his own specific personal needs;
7. The six points above referred can be (or cannot be) implemented in practice, and probably not necessarily by the same order here explained, in reality all it will be depending on the characteristics of each Country.

23. Method according to the claims from 1 to 22, characterized by the Additives of Transformation for Production of Standardized Drinks and Potable Water For Health Profiles have a composition that in reality it will be variable and taking in account several factors, between them the real Health Profiles to Pre-define and to select commercially, as also the permanent evolution of the human science, or the diversity from Country to Country.

24. Method according to the claims from 1 to 23, characterized by the fact that the Additives of Transformation for Production of Standardized Drinks and Potable Water For Health Profiles are formed by Vitamins, Minerals, Amino Acids, Proteins between others, in a composition that normally is dissolved into the Drinks or into the Water (Distilled or Demineralized) staying there generally in ionic state as positives ions (cations) or negatives (anions):

25. Method according to the claim 24, characterized by the fact that the Additives of Transformation for Production of Standardized Drinks and Potable Water For Health Profiles can have in its Vitamins Composition, the principal following elements and chemical compounds:
Vitamins
a) VITAMIN A (Liposoluble) <from 0 to 10 000 U.I., human daily consumption>;
b) VITAMIN B1 (Thiamine-hydr soluble) <fr m 0 to 3 mg, human daily consumption>;
c) VITAMIN B2 (Riboflavin-hydrosoluble) <from 0 to 4 mg, human daily consumption>;
d) VITAMIN B3 (Niacin-hydrosolubl) <from 0 to 3 mg, human daily consumption>;
e) VITAMIN B5 (Pantothenic-hydrosoluble acid) <from 0 to 3 mg, human daily consumption>;
f) VITAMIN B6 (Pyridoxine-hydrosoluble) <from 0 to 4 mg, human daily consumption>;
g) VITAMIN B12 (Cobalamine-hydrosoluble) <from 0 to 10 μg, human daily consumption>;
h) FOLIC ACID (Folacin-hydrosoluble) <from 0 to 800 μg, human daily consumption>;
i) BIOTINE <from 0 to 60 μg, human daily consumption>;
j) VITAMIN C (Ascorbic-hydrosoluble Acid) <from 0 to 100 mg, human daily consumption>;
k) VITAMIN D (Calciferol-liposoluble) <from 0 to 800 U.I., human daily consumption>;
l) VITAMIN E (Tocopherol-liposoluble) <from 0 to 60 U.I., human daily consumption>;
m) VITAMIN K (Menadione) <from 0 to 50 μg, human daily consumption>;
n) VITAMIN K1 (Phytonadione) from 0 to 50 μg, human daily consumption>;
o) VITAMIN P (Bioflavonoids) <from 0 to 50 μg, human daily consumption>;
p) NIACINAMIDE <from 0 to 40 mg, human daily consumption>;
q) PARA-AMINOBENZOIC ACID (PABA) <from 0 to 50 μg, human daily consumption>;
r) PANTOTHENIC ACID <from 0 to 20 μg, human daily consumption>.

26. Method according to the claim 24, characterized by the fact that the Additives of Transformation for Production of Standardized Drinks and Potable Water For Health Profiles can have in its Mineral Composition, the principal following elements and chemical compounds:
Minerals
a) CALCIUM (Ca) <from 0 to 300 mg, human daily consumption>;
b) CALCIUM OF SHELLS OF OYSTERS <from 0 to 300 mg, human daily consumpti n>;
c) CHLORINE (Cl) <from 0 to 60 mg, human daily consumption>;
d) FLUOR (F) <from 0 to 4 mg, human daily consumption>;
e) CHROMIUM (Cr) <from 0 to 50 μg, human daily consumption>;
f) IRON (Fe) <from 0 to 40 mg, human daily consumption>;
g) PHOSPHORUS (P) <from 0 to 300 mg, human daily consumption>;
h) IODINE (I) <from 0 to 300 μg, human daily consumption>;
i) MAGNESIUM (Mg) <from 0 to 200 mg, human daily consumption>;
j) MANGANESE (Mn) <from 0 to 5 mg, human daily consumption>;
k) POTASSIUM (K) <from 0 to 80 mg, human daily consumption>;
l) SELENIUM (Se) <from 0 to 50 μg, human daily consumption>;
m) SODIUM (Na) <from 0 to 150 mg, human daily consumption>;
n) ZINC (Zn) <from 0 to 30 mg, human daily consumption>;
o) COPPER (Cu) <from 0 to 4 mg, human daily consumption>;
p) GOLD (Au) <from 0 to 20 μg, human daily consumption>;
q) SILVER (Ag) <from 0 to 20 μg, human daily consumption>;
r) TIN (Sn) <from 0 to 20 μg, human daily consumption>;
s) MOLIBDENIUM (Mo) from 0 to 50 μg, human daily consumption>;
t) NICKEL (Ni) <from 0 to 10 μg, human daily consumption>;
u) SILICIUM (Si) <from 0 to 20 μg, human daily consumption>;
v) VANADIUM (V) <from 0 to 20 μg, human daily consumption>.

27. Method according to the claim 24, characterized by the fact that the Additives of Transformation for Production of Standardized Drinks and Potable Water For Health Profiles can have in its Amino Acid Composition, the principal following elements and chemical compounds:
Amino Acids
a) ASPARTIC ACID <from 0 to 100 μg>;
b) GLUTAMIC ACID <from 0 to 100 μg>;
c) ALANINE <from 0 to 100 μg>;
d) ARGININE <from 0 to 100 μg>;
e) BCAA—AMINO ACID CHAINS <from 0 to 100 μg>;
f) CYSTEINE <fr m 0 to 100 μg>;
g) FENILANINE <from 0 to 100 μg>;
h) GLYCINE <from 0 to 100 μg>;
i) HISTIDINE <from 0 to 100 μg>;
j) L-CARNITINE <from 0 to 100 μg>;
k) LYSINE <from 0 to 100 μg>;
l) METHYONINE <from 0 to 100 μg>;
m) ORNITHINE <from 0 to 100 μg>;
n) PROLINE <from 0 to 100 μg>;
o) SERINE <from 0 to 100 μg>;
p) TYROSINE <from 0 to 100 μg>;
q) THREONINE <from 0 to 100 μg>;
r) TRYPTOPHANE <from 0 to 100 μg>.

28. Method according to the claim 24, characterized by the fact that the Additives of Transformation for Production of Standardized Drinks and Potable Water For Health Profiles can have in its Protein Composition, the principal following elements and chemical compounds:
Proteic Suplements
<From 0 to 200 mg>—Normally prepared from soy, white part of the egg, the skimmed milk serum.

29. Method according to the claim 24, characterized by the fact that the Additives of Transformation for Production of Standardized Drinks and Potable Water For Health Profiles also can have an Extra Supplements Composition, the principal following elements and chemical compounds:
Extra Suplements
a) ACIDOPHILUS <from 0 to 50 mg>—It is about the lactobacillus acidophilus that, with the fermentation of carbohydrate originates the lactic add;
b) ODOURLESS GARLIC <from 0 to 50 mg>—The rich composition of the oil of garlic (Potassium, Phosphorus, Calcium, Proteins, Vitamins C and Complex B), presented in deodorized form, beyond rich in amino adds;
c) ENZYME OF PAPAYA <from 0 to 50 mg>—Digestive enzyme, extracted from the papaya;
d) OMEGA 3—EPA <from 0 to 50 mg>—Unsaturated oil (without fats) and without metals weighed, extracted of the salmon. It contains EPA (eicosapentaenoic acid) and DHA (decosahexaenoic acid) and vitamins, A, B and E.

30. Method according to the claims from 1 to 29, characterized by this patent to be applied essentially to satisfy the biological nutritional needs, of the World Consumers, through the regular use of Standardized Drinks and Potable Waters according to the personalized, predefined Standards and HEALTH PROFILES; so here are presented some of the Illnesses and Classifications, originated by many factors between them the lack of nutrients, that will be used for the Definition and Classification of the Health profiles that the Additives of Transformation for Production of Standardized Drinks and Potable Water For Health Profiles will satisfy through the Method here Patented:
Uric Acid—Gout; Alcoholism; Allergies; Anemia; Anorexia; Arterioscleroses; Arthritis; Renal Calculus in Kidneys and Vesicle; Cancer; Growth; High Cholesterol; Depressions; Dehydration; Malnutrition; Hormones Clutters; Sports—Athletes; Diabetes Mellitus; Illnesses of the Genetic Forum (Genetic Disorders); Illnesses of the Psychological Forum; Illnesses of the Psychiatric Forum; Illnesses of Bones; Pains of Ear; Illnesses of the Skin; Illnesses of the Alimentary and Digestive System; Illnesses of the Cardiovascular System; Illnesses of Sanguineous Circulatory System; Illnesses of the Hepatic System; Illnesses of the Immunology System, Illnesses of the Lymphatic System; Illnesses of the Nervous System; Illnesses of the Ophthalmologic System; Illnesses of the Respiratory System; Illnesses of the Sexual System; Illnesses of the Urinary and Renal System; Fatigue; Infertility; HIV/AIDS; Leukemia; Maternity; Menopause; Obesity; Corporal odor; Osteoporosis; High Arterial Pressure; Arterial Pressure Decrease; Menstrual problems; Prostate; Puberty; Kidneys; Rheumatism; Toxic-dependence—Drugs; Ulcer; Oldness; Vesicle.
